(19) United States
(12) Patent Application Publication
(10) Pub. No.: US 2007/0213118 A1
(43) Pub. Date: Sep. 13, 2007

(54) Method For Participating In Lottery Draw Over A Cellular Network And System Thereof

(76) Inventor: Yoav Karmazin, Tel Aviv (IL)

Correspondence Address: EMPK & SHILOH, LLP, 116 JOHN ST,, SUITE 1201, NEW YORK, NY, 10038, US

(21) Appl. No.: 10/593,154

(22) PCT Filed:
(86) PCT No.: PCT/IL05/00248

(30) Foreign Application Priority Data
Mar. 18, 2004 (IL) 160972

(51) Int. Cl. A63F 9/24

(52) U.S. Cl. 463/17

(57) ABSTRACT

A system and method are provided to allow a user of a cellular device to participate in lottery drawings over a cellular network. The method may include, for example, providing a central lottery computer for providing data related to lottery drawings, providing a cellular drawing center linked to the cellular network and to the central lottery computer, the cellular drawing center to be used for mediating between a cellular device and die central lottery computer; dialing, via the cellular device, an access code for accessing the cellular drawing center, identifying, by the cellular drawing center, the phone number assigned to the cellular device and executing a recorded instruction for aiding the user of the cellular device to execute the selection required in order to participate in one or more of the lottery drawings, submitting a confirmation message, optionally including details of the lottery drawings in which the user is participating, to the cellular device for reporting to the user, and/or charging and/or crediting the user via the billing system of the cellular network.

### FIELD OF THE INVENTION

The present invention relates to the field of services over the cellular network. More particularly, the invention relates to a method for participating in lottery draws via the cellular network which include billing.

### BACKGROUND OF THE INVENTION

In a typical lottery game, a person who wishes to participate in a lottery draw or other type of wager, usually needs to go to a specific point of sale terminal in order to buy a lottery ticket or other wagering ticket. For example, the lottery ticket usually contains a limited set of numbers that is to be compared to a set of winning numbers at a time subsequent to the purchase of the lottery ticket. A participant in such a draw often has the option of selecting the set of numbers for the lottery ticket or allowing the point of sale terminal to produce a lottery ticket with a set of numbers which are chosen automatically.

Further, the use of wireless networks, such as cellular telephone networks, is increasing. Cellular telephone users often find it convenient to conduct as many transactions as possible using their cellular telephones. For example, WO 01/03786 discloses a wireless lottery game system which includes cellular phones used by the user for receiving an indication from a processor whether a ticket is determined to be the winning ticket and WO 00/77753 discloses a lottery game operating method which involves allocating a prize to the participant whose lottery number matches tie winning lottery number when compared. However, in order to participate in such draws, the user needs to perform several tasks prior to his participation in the draw, such as payment in advance via a credit card or another similar method. Such tasks such as asking the user to enter specific information regarding payment via his cellular device (e.g., cellular telephone), are required from, and this sometimes might be annoying while using a cellular device.

Therefore, it is an object of the present invention, to provide a method for allowing users to participate in lottery drawings without the need to perform additional tasks or provide extra information regarding the payment method.

It is another object of the present invention to provide a method for allowing users to participate in lottery drawings without the necessity of going to a specific point of sale terminal.

Other objects and advantages of the invention will become apparent as the description proceeds.

### SUMMARY OF THE INVENTION

The present invention relates to a method for allowing a user of a cellular device to participate in lottery drawings over a cellular network, said method comprising: a) providing a central lottery computer for providing data related to lottery drawings; b) providing a cellular drawing center linked to said cellular network and to said central lottery computer, said cellular drawing center is used for mediating between a cellular device and said central lottery computer; c) dialing, via said cellular device, an access code for accessing said cellular drawing center; d) identifying, by said cellular drawing center, the phone number assigned to said cellular device and executing recorded instruction for aiding the user of said cellular device to execute the selection required in order to participate in one or more of said lottery drawings; e) submitting a confirmation message to said cellular device for reporting to said user, details of the lottery drawings in which said user is participating; and f) charging and/or crediting said user via the billing system of said cellular network.

According to a preferred embodiment of the present invention, the method further comprises, at least during the initial attempt of the user to participate in the draw, inquiring said user to enter a pre-provided security code for preventing unwanted participating attempt to take place.

Preferably, the cellular drawing center further comprises speech recognition means for allowing the user to execute selections by way of speech or other verbal communication methods.

According to all aspect of the present invention, the selections of the user are executed by performing operations selected from the group consisting of: pressing keys on the keyboard of the cellular device, executing selections by speech or a combination thereof.

Preferably, the method of the present invention further comprises providing means for participating in the draw via WAP application.

According to a preferred embodiment of the invention, the confirmation message is further submitted to predefined application, such e-mail, voice mail and the like.

The present invention further relates to a system for allowing the user to participate in lottery drawings over a cellular network, said system comprises: a) a central lottery computer for providing data related to lottery draws; b) a cellular drawing center, wherein said cellular drawing center is linked to said computer and said cellular network; c) a cellular device for allowing accessing cellular drawing center; d) means for identifying the phone number assigned to said cellular device and means for executing recorded instruction for aiding said user to execute selections in order to participate in one or more of said lottery drawings; e) means for submitting a confirmation message to said cellular for reporting to said user details of the lottery drawings in which said user is participating; and f) means for charging and/or crediting said user via the billing system of said cellular network.

According to a preferred embodiment of the present invention, the system further comprises means for identifying a pre-provided code, at least during the initialize attempt of the user to participate in the draw, for preventing unwanted attempt to participate in a draw from talking place (e.g., by unwanted persons or by accidental dial)

Preferably, the cellular drawing center further comprises speech recognition means for allowing the user to execute the selections by speech.

Preferably, the method of the present invention further comprises means for participating in the drawing via application(s) based on Wireless Application Protocol (WAP).

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically illustrates a system for allowing user to participate in lottery drawings over a cellular network, according to a preferred embodiment of the present invention; and

FIG. 2 is a flowchart showing the process used by the system of FIG. 1 to allow a user participating in lottery drawings, according to a preferred embodiment of the present invention.

### DETAILED DESCRIPTION OF PREFERRED EMBODIMENTS

In this application, the words “cellular telephone”, “cell phone” and “cellular device” are used interchangeably to designate a wireless communications device.

The invention will now be described primarily with reference to the examples of a cellular telephone. These examples are provided merely to illustrate the invention and are not intended to limit its scope in any way. It should be understood that the invention can be applied mutatis mutandis to other devices such as pocket PC, Personal Digital Assistant, etc., provided with communication capabilities over a cellular network.

The present invention relates to a system for allowing user to participate in lottery draws over a cellular network, wherein any payment or participating fee is done via the billing system of the cellular network operator. As a result the user can be debited or credited (e.g., via his bank account) through a debit note from the billing system of the cellular network, whereby no additional details regarding the payment method are required when a user wishes to participate in such lottery draws.

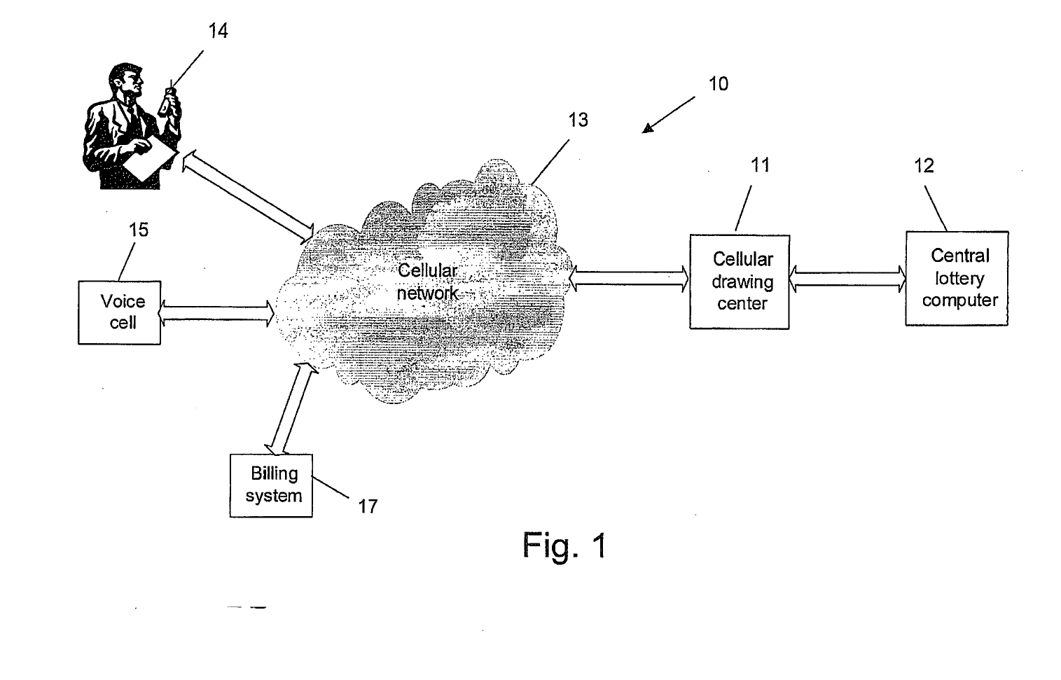

FIG. 1 schematically a system 10 for allowing user(s) to participate in lottery drawings over a cellular network, according to a preferred embodiment of the present invention. System 10 comprises a Cellular Drawing Center (CDC) 11, a Central Lottery Computer (CLC) 12, a wireless communication device 14, cellular network 13 and billing system 17.

CDC 11 is linked to the cellular network 13 and to the CLC 12. CLC 12 stored data related to lottery draws, such as dates of draws, winning tickets, participating acknowledgments for users, data related to credit or charge of users, etc. CDC 11 is used to allow users to participate in lottery draws via the cellular network, by mediating between the wireless communication device 14 and CLC 12.

In order to allow a user to participate in lottery draws, CDC 11 performs the following tasks:
identifying the phone number assigned to the wireless communication device 14 after a user dials, via a wireless communication device 14, an access code for accessing into the cellular drawing center 11;
executing recorded instructions for aiding the user to make selections in order to participate in one or more available or future lottery drawings;
After the user has completed selecting his choice, submitting a confirmation message to a wireless communication device 14 and/or to other electronic device or method, such as PDA, e-mail account, Voice cell 15 etc., for providing the user with any suitable details regarding the lottery drawings in which he has chosen to participate; and finally
charging and/or crediting the user of cellular device 14 via the billing system 17 used by the operator of the cellular network 13.

CDC 11 may further perform the following tasks: notifying the user regarding further draws information, such as winning information, amount of a prize, etc., by receiving data relating to the draws from the CLC 12, transferring the received data to the wireless communication device 14 Preferably, but not limitatively the data can be processed by the CDC 11 in order to provide the user with data which is only relevant to him, such as information regarding only the draws in which the user chooses to participate.

The wireless communications device 14 may be a cellular telephone. The wireless communications device 14 may include a display, and the indication regarding the relevant draws, as well as its winning may be displayed to the user on the display. The wireless communications device 14 may include a keypad for dialing the access code to and/or to make the request to participate in draws. Alternatively, the CDC 11 may farther include speech recognition means (not shown) in order to allow the user dial and/or make its draw request in its own voice, as it is known by a person skilled in the art. Preferably, the preferences or requests of the user are executed by performing operations selected from the group consisting of: pressing keys on the keyboard of the cellular device, executing voice commands or a combination thereof.

Preferably, the issuing of “gaming ticket(s)” in response to a request made by the user is done by the CLC 12. For example, the CLC 12 may obtain the gaming tickets from a ticket database.

According to a preferred embodiment of the present invention, the system further includes security means in order to avoid having unwanted persons participating in a draw while using the wireless communication device of another person or which they are not allowed to use for that purpose. Preferably, such security means are used, at least during the initial attempt of the user to participate in a draw, requesting the user to enter a security code, which was provided to him by the operator of CDC 11 or by its cellular network operator.

Preferably, the method of the present invention further comprises means for participating in the drawing via WAP application, as it known to a person skilled in the art.

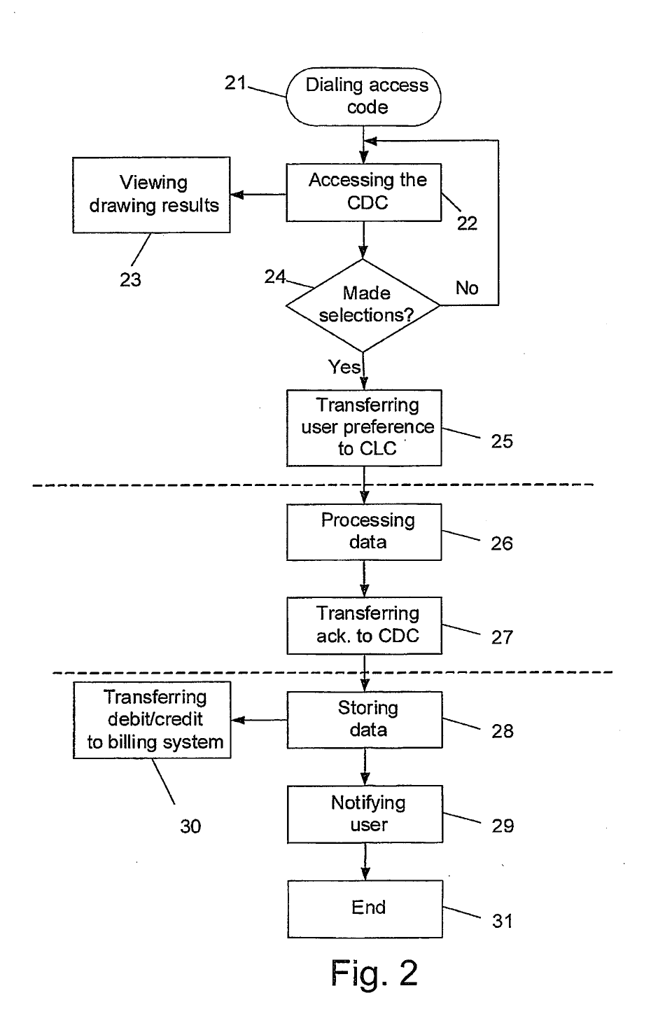

FIG. 2 is a flowchart showing the process used by the system of FIG. 1 to allow a user to participate in lottery drawings, according to a preferred embodiment of the present invention. The flowchart starts in block 21, in which a user accesses the CDC 11 via his wireless communication device 14. At the next step, block 22, the user has two main options;
one—to view or hear the drawings results in which he participated (block 23);
two—to participate in new lottery drawings. Whenever the user chooses to participate in new draw(s) and makes its selection (block 24), then at the next step, block 25, the user selections are transferred from the CDC 11 to CLC 12.

At the next step, block 26, the CLC 12 processes the data received from the CDC 11 regarding the preferences of the user, in order to add the user's preference to the lottery drawings. At the next step, block 27, the CLC 12 transfers an acknowledgment to the CDC 11 saying that the user is participating in its selected lottery drawings which include the drawing details, such as the ticket number.

At the next step, block 28, CDC 11 stores data related to drawing details received from the CLC 12. At the next step, the CDC 11 performs two main tasks; one—transferring debit details to the billing system 17; two—notifying the user regarding the drawing details and confirming his participation in the selected lottery draws.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A method for allowing a user of a cellular device to participate in lottery drawings over a cellular network, comprising:
i) providing a central lottery computer for providing data related to lottery drawings;
ii) providing a cellular drawing center linked to said cellular network and to said central lottery computer, said cellular drawing center is used for mediating between a cellular device and said central lottery computer;
iii) dialing, via said cellular device, an access code for accessing said cellular drawing center;
iv) identifying, by said cellular drawing center, the phone number assigned to said cellular device and executing recorded instruction for aiding the user of said cellular device to execute the selection required in order to participate in one or more of said lottery drawings;
v) submitting a confirmation message to said cellular device for reporting to said user, details of the lottery drawings in which said user is participating; and
vi) charging and/or crediting said user via the billing system of said cellular network.

2. A method according to claim 1, further comprising, at least during the initial attempt of the user to participate in the draw, requesting said user enter a pre-provided security code for preventing unwanted participating attempt to take place.

3. A method according to claim 1, wherein the cellular drawing center further comprising providing speech recognition means for allowing the user to execute selections by speech.

4. A method according to claim 1, wherein the selections of the user are executed by performing operations selected from the group consisting of: pressing keys on the keyboard of the cellular device, executing selections by speech or a combination thereof.

5. A method according to claim 1, wherein the confirmation message is further submitted to predefined application(s).

6. A system for allowing a user of a cellular device to participate in lottery drawings over a cellular network, comprising:
i) a central lottery computer for providing data related to lottery draws;
ii) a cellular drawing center, wherein said cellular drawing center is linked to said computer and said cellular network;
iii) a cellular device for allowing accessing cellular drawing center;
iv) means for identifying the phone number assigned to said cellular device and means for executing recorded instruction for aiding said user to execute selections in order to participate in one or more of said lottery drawings;
v) means for submitting a confirmation message to said cellular for reporting to said user details of the lottery drawings in which said user is participating; and
vi) means for charging and/or crediting said user via the billing system of said cellular network.

7. A system according to claim 6, further comprising means for identifying a pre-provided code, at least during the initialize attempt of the user to participate in the draw, for preventing unwanted participation from taking place.

8. A system according to claim 6, in which the cellular drawing center further comprises speech recognition means for allowing the user to execute selections by speech.

9. A method for allowing user to participate in lottery drawings over a cellular network, substantially as described and illustrated.

10. A system for allowing user to participate in lottery drawings over a cellular network, substantially as described and illustrated.
